(19) United States
(12) Patent Application Publication
(10) Pub. No.: US 2016/0146732 A1
(43) Pub. Date: May 26, 2016

(54) Particle Detector And Method For Detecting Particles

(71) Applicant: SIEMENS AKTIENGESELLSCHAFT, Muenchen (DE)

(72) Inventors: Reinhard Freitag, Muenchen (DE); Robert Schrobenhauser, Muenchen (DE)

(73) Assignee: Siemens Aktiengesellschaft, Muenchen (DE)

(21) Appl. No.: 14/900,677

(22) PCT Filed: Jun. 12, 2014
(86) PCT No.: PCT/EP2014/062217

§ 371 Date: Dec. 22, 2015

(30) Foreign Application Priority Data
Jun. 24, 2013 (DE) 10 2013 211 885.6

(51) Int. Cl. G01N 21/53; G01N 15/14

(52) U.S. Cl. CPC G01N 21/53; G01N 15/1436; G01N 2015/1452; G01N 2201/0612; G01N 2201/0638

(57) ABSTRACT

A particle detector for detecting particles in a gas may include a measurement chamber, a light source, at least one light sensor, and a first lens. The measurement chamber may have a gas inlet with a gas inlet nozzle, through which the gas flows into the measurement chamber along a flow direction. The light source may emit light along an optical beam direction. The first lens may have an electrically adjustable focus.

### CROSS-REFERENCE TO RELATED APPLICATIONS

This application is a U.S. National Stage Application of International Application No. PCT/EP2014/062217 filed Jun. 12, 2014, which designates the United States of America, and claims priority to DE Application No. 10 2013 211 885.6 filed Jun. 24, 2013, the contents of which are hereby incorporated by reference in their entirety.

### TECHNICAL FIELD

This disclosure provides a particle detector and a method for detecting particles. More specifically, it provides a detector and method for detecting particles in a gas stream.

### BACKGROUND

In order to detect particles in gases, substantially optical measurement methods are used, in which visible light or infrared light is radiated from a light source onto the gas flow, and in which the light that is scattered at the particles is measured at particular angles relative to the original beam direction of the light. The particle-containing gas is to this end introduced, via a gas inlet nozzle, into a measurement chamber where the resulting gas flow typically passes through a laser beam. The light scattering of particles in gas flows depends on the particle size, the refractive index of the particles, and on the wavelength of the light. For particle sizes that are small compared to the wavelength, the light scattering and its dependence on angle and size are described by the theory of Rayleigh scattering. For particle sizes approximately in the range of the wavelength, the theory of Mie scattering provides a description of the optical effects. In both cases, the result is a known distribution of the scattering angles in dependence on the particle size, with the result that the particle size can be determined from measurements of the scattered light at a plurality of angles. It is possible to determine the particle size from the amplitude of individual scattering signals even in the case of detecting scattered light under only one predetermined angle, if the measurement device was previously suitably calibrated. By way of example, the scattered light sensor that is arranged at a particular angle with respect to the beam direction is used to detect for each particle in the gas flow a signal pulse, the amplitude of which is characteristic of the size of the particle. From the number of such pulses, a measure of the number of particles transported by the gas flow within the considered time interval can be obtained. In addition, a size distribution for this particle number is obtained from the evaluation of the amplitudes, for example by comparison with threshold values.

Typical standards and limit values for the space and ambient air are, however, not related to the size but to the mass. However, laser-based detection systems have not yet been able to ascertain those directly. Known approaches for a solution can be found, for example, in connecting filter or selection systems upstream of the actual measurement system, for example a “differential mobility analyzer,” in which the particles are charged by a radioactive source according to a standard charge distribution, and then electrostatically selected according to the charge-to-mass ratio of the particle in an exit window. Alternatively, the average mass of the particles for the environment is estimated and the ascertained particle sizes are multiplied by an assumed density. In order to ascertain a detailed mass distribution, generally entirely different measurement methods are used.

### SUMMARY

The present disclosure provides a simplified arrangement for capturing particles while simultaneously capturing the mass, and an associated method.

One embodiment of the particle detector for detecting particles in a gas comprises a measurement chamber having a gas inlet and a gas inlet nozzle, through which the gas is made to flow into the measurement chamber along a flow direction. It furthermore comprises a light source for emitting light along an optical beam direction and at least one light sensor for capturing proportions of the light scattered at the particles. The particle detector finally comprises a first lens with an electrically adjustable focus.

In electrically tunable lenses, the focus can be varied by way of a voltage being applied. It is thus possible to scan points in space along the laser beam propagation direction. Variable focus lenses may be used to execute a method for detecting particles in a gas, in which the following steps are carried out:
letting the gas containing particles flow through the gas inlet nozzle into the measurement chamber,
sequentially adjusting the position of the light beam waist using the first lens to at least two different positions within the measurement chamber,
emitting light into the gas flow by means of the light source and measuring proportions of the light scattered at the particles by means of the light sensor at each of the positions.

The particle detector may comprise an aspherical second lens which follows the light source and the first lens in the optical beam direction. If the light source, the first and the second lens are arranged such that the light from the light source is imaged divergently, in particular slightly divergently, onto the second lens, then the particle detector may be particularly effective. An exemplary particle detector may allow the generation of a light beam, the beam waist position of which in the measurement chamber can be varied by way of the voltage that is applied to the lens. Beam waist here is understood to mean the region of the light beam where the light beam exhibits the highest concentration, that is to say the smallest cross section.

In the measurements, the position of the light beam waist is moved to and fro. The particle size distribution is measured at least at two positions. The positions that can be selected here are known by way of the set lens voltage or can be determined from the lens voltage. In configurations of the measurement method, more than two positions, for example five or ten positions, may be used.

The particle detector may include an evaluation device for evaluating signals of the light detector, which is configured to ascertain from the signals the mass of at least some of the particles.

The disclosed particle detector may provide the following advantages:

In all positions, even far away from an idealized intersection between the optical beam direction and the direction of the gas flow produced from the inlet nozzle, the sensitivity is at a maximum, since the light beam is focused very densely at that point when such a position is set.

The light sensor can be arranged such that light scattered at the particles is incident on the light sensor at a scattering angle of between 1° and 45°. Some embodiments may be arranged for an angular range between 1° and 30°.

The optical beam direction may be arranged perpendicular to the flow direction of the gas. This arrangement provides an intersection of the gas flow with the light beam of the light source in a predetermined volume. The perpendicular arrangement, however, is not a prerequisite for operating the particle detector. In most embodiments, the gas flow and the light beam intersect at some location.

### BRIEF DESCRIPTION OF THE DRAWINGS

FIG. 1 shows a cross section of the particle detector having a liquid lens in a schematic side view,

FIG. 2 illustrates a first light beam profile in the case of the measurement of different positions in the gas flow by way of tuning the liquid lens,

FIG. 3 illustrates a second light beam profile in the measurement of different positions in the gas flow by way of tuning the liquid lens.

### DETAILED DESCRIPTION

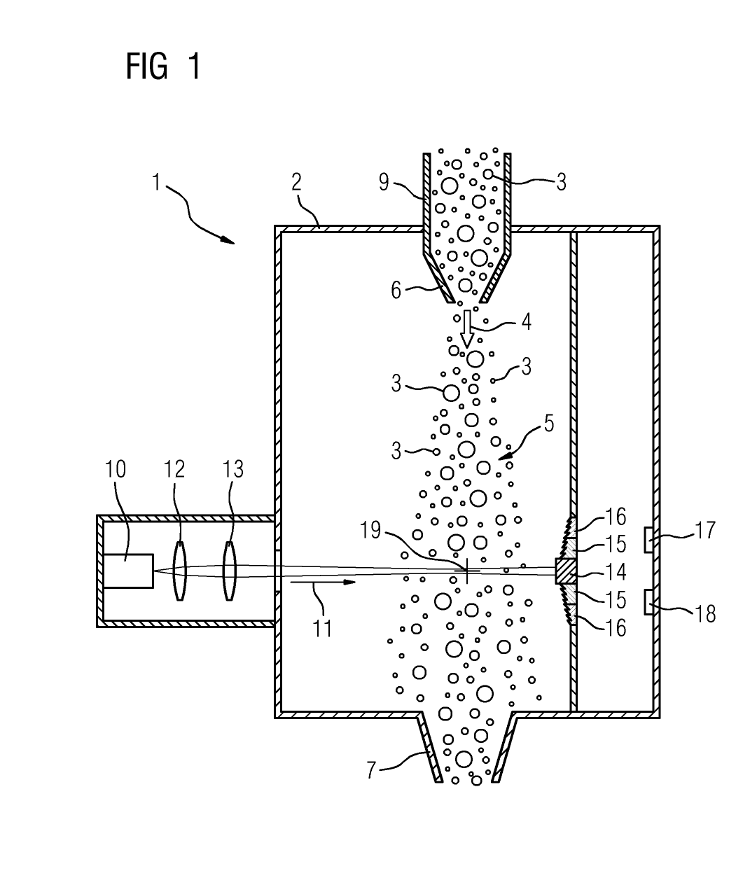

PCT FIG. 1 shows a schematic cross section of a particle detector 1 according to some embodiments of the present disclosure. The particle detector 1 comprises a measurement chamber 2 having a gas inlet 9 and a gas inlet nozzle 6 at its upper side. Gas enters the measurement chamber 2 through the gas inlet nozzle 6, resulting in a gas flow 5 that is aligned along a flow direction 4 through the measurement chamber 2. In this example, a gas outlet 7 is arranged at the lower end of the measurement chamber 2, which gas outlet 7 is expediently connected to a vacuum pump (not illustrated here). The particles 3 contained in the gas flow 5 are, in this example, represented as a mixture of round particles 3 of different sizes. However, another particle distribution is also possible, in particular a distribution of particles 3 of greatly varying sizes and shapes. The size of the particles 3 relative to the measurement chamber 2 is not illustrated to scale—exaggerating the size for clarity—in FIG. 1.

The particle detector 1 may comprise a laser diode 10 in a chamber that is connected to the measurement chamber 2. The laser diode 10 emits a laser beam in a beam direction 11, which is substantially perpendicular to the flow direction 4 of the gas flow 5. Arranged in the beam path of the laser beam is first a liquid lens 12, the refractive power of which is electrically adjustable. Arranged downstream of the liquid lens, in the laser beam, is an aspherical second lens 13.

Provided in the region of incidence of the laser beam on a wall of the measurement chamber 2 is a beam trap 14 which brings about absorption of the laser beam that is largely free of reflections. Provided around the beam trap 14 are a first and a second annular Fresnel lens 15, 16, which bring about focusing of scattered light of particular scattering angle ranges onto a first and second photodiode 17, 18. The electrically controllable elements laser diode 10, liquid lens 12 and the photo diodes 17, 18 are connected to corresponding control electronics or evaluation electronics, which are not illustrated in FIG. 1.

As indicated in FIG. 1, the gas flow 5 within the measurement chamber 2 is divergent, i.e., its cross section widens during the movement from the gas inlet nozzle 6 to the gas outlet 7. Here, large and/or heavy particles 3 move in the gas flow 5 predominantly in the center of the gas flow 5, since they do not diffuse as easily into the outer regions. Smaller particles 3, on the other hand, diffuse easily into the outer regions of the gas flow 5 during the movement in the gas flow 5. Located at the level of the laser beam in the regions of the gas flow that are off-center, in the regions near the laser diode 10 near the beam trap 14, is therefore an above-average amount of many light particles 3, while many of the heavy particles 3 are concentrated near the intersection 19 of flow direction 4 and optical beam direction 11.

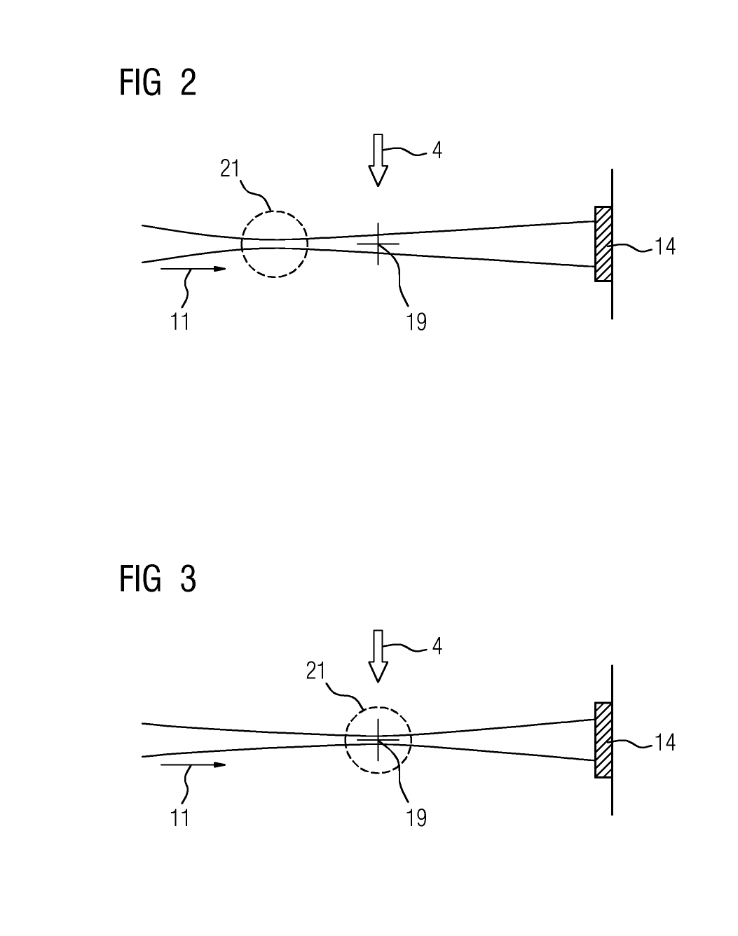

FIG. 2 illustrates a laser beam shape as can be generated by the liquid lens by way of corresponding electric control. The laser beam is here slightly divergent up to the beam trap 14. The beam waist at region 21 having the highest concentration of the laser beam is located here in the optical beam direction a millimeter upstream of the intersection 19 of flow direction 4 and optical beam direction 11. With such a setup of the laser beam, lighter particles 3 are measured in the main axis.

FIG. 3 shows another example laser beam shape, as can likewise be generated by the liquid lens by way of corresponding electric control. The region 21 having the highest concentration of the laser beam is here located directly at the intersection 19 of flow direction 4 and optical beam direction 11, that is to say substantially in the center of the gas flow 5. Such a setup of the laser beam may provide measurement of heavier particles 3.

What is true for all positions for the beam waist of the laser is that, owing to the higher concentration and thus brightness of the laser beam in the region 21, the scattering signal of the particles 3 from this region 21 in each case significantly predominates in the measured signal. Particles 3 that pass through the laser beam in the beam direction upstream or downstream of the beam waist, on the other hand, reflect significantly less light.

Particles 3 that pass through the laser beam laterally—perpendicular to the beam direction and perpendicular to the flow direction 4—outside the center of the gas flow 5 are, in large part, not taken into account in the evaluation. These particles 3 have a prolonged passage period through the laser beam, while particles 3 that pass centrally through the laser beam have a shorter (minimum) passage time.

By controlling at least two, ideally three, five or seven positions for the region 21 having the highest concentration of the laser beam and measuring the scattering of the laser beam at the corresponding location for example for a time of one minute, two minutes or another measurement time, it is thus possible to establish a profile which indicates a measured number of particles in dependence on their size and position. The mass of the respective particles 3 is then concluded from the position or the measured profile, where a mass distribution can also be determined in addition to a pure size distribution. What is necessary for concluding the mass from the position is to use calibration data or a relationship that can be ascertained by way of calculation. In some embodiments of the present teaching, the positions are located between the intersection 19 and the beam trap 14. At these positions, the region 21, the laser beam waist, is located further away from the liquid lens 12. As a result, the divergence of the laser beam is reduced and the beam trap 14 traps a larger proportion of the laser beam than at positions that are located upstream of the intersection 19, viewed from the liquid lens 12. As a result, the amount of background light that reaches the photodiodes 17, 18 is reduced in turn and thus the signal-to-noise ratio is improved. This is particularly advantageous because, lighter particles 3, which are typically smaller and thus require the highest possible signal-to-noise ratio for successful measurement, are more likely to be located away from the intersection 19.

What is claimed is:

1. A particle detector for detecting particles in a gas, comprising:
a measurement chamber having a gas inlet with a gas inlet nozzle, through which the gas is made to flow into the measurement chamber along a flow direction,
a light source for emitting light along an optical beam direction,
at least one light sensor, and
a first lens with an electrically adjustable focus.

2. The particle detector according to claim 1 having further comprising an aspherical second lens.

3. The particle detector according to claim 2, in which the light source, the first and the second lenses are arranged such that the light from the light source is imaged divergently onto the second lens.

4. The particle detector according to claim 1 further comprising an evaluation device which takes into account stored values for the relationship between the particle mass and a lateral movement of the particles in the gas.

5. The particle detector according to claim 1 further comprising an evaluation device which is configured to ascertain a relationship between the particle mass and a lateral movement of the particles in the gas by way of calculation.

6. The particle detector according to claim 1, further comprising a beam trap that is arranged in the optical beam direction on that side of the measurement chamber that is opposite the light source.

7. A method for detecting particles in a gas, using a particle detector including a measurement chamber, a light source, at least one light sensor, and a first lens having an electrically adjustable focus, the method comprising:
letting the gas containing particles flow through a gas inlet nozzle into the measurement chamber,
sequentially adjusting the position of a light beam waist using the first lens to at least two different positions within the measurement chamber,
emitting light into a gas flow through the measurement chamber by means of the light source and measuring proportions of the light scattered at particles by means of the light sensor at each of the positions.

8. The method as claimed in claim 7, in which positions that are located along the optical beam direction at the intersection of the gas flow and emitted light, or further away from the light source are used as the positions.

9. A system for detecting particles in a flowing gas, the system comprising:
a measurement chamber having an inlet through which the gas is made to flow into the measurement chamber along a flow direction;
a light source for emitting light along an optical beam path;
at least one light sensor; and
a first lens in the path of the optical beam with an electrically adjustable focus.

10. A system according to claim 9, wherein the inlet comprises a nozzle.

11. A system according to claim 9, further comprising an aspherical second lens.

12. A system according to claim 9, wherein which the light source, the first lens, and the second lenses are arranged to divergently image the light from the light source onto the second lens.

13. A system according to claim 9, further comprising an evaluation device for analysing the signal of the at least one light sensor, which stores values for the relationship between particle mass and a lateral movement of particles in the gas.

14. A system according to claim 9, further comprising an evaluation device for analysing the signal of the at least one light sensor, which determines a relationship between the particle mass and a lateral movement of the particles in the gas by way of calculation.

15. A system according to claim 9, further comprising a beam trap arranged in the optical beam path on a side of the measurement chamber opposite the light source.
